(19) United States
(12) Patent Application Publication
(10) Pub. No.: US 2005/0278577 A1
(43) Pub. Date: Dec. 15, 2005

(54) Automatically generating observations of program behavior for code testing purposes

(76) Inventors: Roongko Doong, Palo Alto, CA (US); Luigi Alberto Pio di Savoia, Mountain View, CA (US)

Correspondence Address: A. RICHARD PARK, REG. NO. 41241;PARK, VAUGHAN & FLEMING LLP, 2820 FIFTH STREET, DAVIS, CA, 95616, US

(21) Appl. No.: 10/859,265

(22) Filed: Jun. 1, 2004

(51) Int. Cl. G06F 11/00

(52) U.S. Cl. 714/38

(57) ABSTRACT

One embodiment of the present invention provides a system that automatically generates observations of program behavior for code testing purposes. During operation, the system analyzes the code-under-test to determine a set of test inputs. Next, the system exercises the code-under-test on the set of test inputs to produce a set of test results. Finally, the system analyzes the set of test results to automatically generate observations, wherein the observations are boolean-valued expressions containing variables and/or constants which are consistent with the set of test inputs and the set of test results.

### BACKGROUND

1. Field of the Invention

The present invention relates to techniques for testing software. More specifically, the present invention relates to a method and an apparatus for automatically generating observations of program behavior for code testing purposes.

2. Related Art

Software testing is a critical part of the software development process. As software is written, it is typically subjected to an extensive battery of tests ensure that it operates properly. It is far preferable to fix bugs in code modules as they are written, to avoid the cost and frustration of dealing with them during system large-scale system tests, or even worse, after software is deployed to end-users.

As software systems grow increasingly larger and more complicated, they are becoming harder to test. The creation of a thorough set of tests is difficult (if not impossible) for complex software modules because the tester has to create test cases to cover all of the possible combinations of input parameters and initial system states that the software module may encounter during operation.

Moreover, the amount of test code required to cover the possible combinations is typically a multiple of the number of instructions in the code under test. For example, a software module with 100 lines of code may require 400 lines of test code. At present, this testing code is primarily written manually by software engineers. Consequently, the task of writing this testing code is a time-consuming process, which can greatly increase the cost of developing software, and can significantly delay the release of a software system to end-users.

Furthermore, the manual process of writing testing code can also cause a number of problems. Even a simple software module may require hundreds (or thousands) of different tests to exercise all of the possible execution pathways and conditions. Consequently, developers who write testing code are likely to overlook some of the execution pathways and conditions. Furthermore, if the developer who writes the testing code is the same developer who wrote the original code, the developer is unlikely to create testing code that will catch logical errors that the developer made while writing the original code.

Hence, what is needed is a method and an apparatus for generating a comprehensive set of tests for a software system without the above-described problems.

### SUMMARY

One embodiment of the present invention provides a system that automatically generates observations of program behavior for code testing purposes. During operation, the system analyzes the code-under-test to determine a set of test inputs. Next, the system exercises the code-under-test on the set of test inputs to produce a set of test results. Finally, the system analyzes the set of test results to automatically generate observations, wherein the observations are boolean-valued expressions containing variables and/or constants which are consistent with the set of test inputs and the set of test results.

In a variation on this embodiment, analyzing the code-under-test to determine the set of test inputs involves analyzing the code-under-test to determine test data for the code-under-test, and to determine a number of test executions. It also involves producing the set of test inputs by creating various combinations of the test data to exercise code-under-test.

In a variation on this embodiment, the system presents the observations to a user, and allows the user to select observations that reflect intended behavior of the code-under-test. Next, the system promotes the selected observations to become assertions, which will be verified when a subsequent version of the code-under-test is exercised during subsequent testing.

In a variation on this embodiment, the system also allows the user to manually enter assertions, and to modify observations (or assertions) to produce assertions.

In a variation on this embodiment, presenting the observations to the user involves filtering and/or ranking the observations based on a relevance score before presenting the observations to the user.

In a variation on this embodiment, the system verifies assertions by exercising a subsequent version of the code-under-test on a subsequent set of test inputs to produce a subsequent set of test results. Next, the system verifies that the assertions hold for the subsequent set of test inputs and the subsequent set of test results. Finally, the system reports pass/fail results for the assertions to the user, thereby allowing the user to fix any problems indicated by the pass/fail results.

In a further variation, prior to exercising the subsequent version of the code-under-test, the system analyzes the subsequent version of the code-under-test to determine the subsequent set of test inputs to be used while exercising the subsequent version of the code-under-test.

In a variation on this embodiment, the system generalizes the observations, whenever possible, by using variables instead of constants in the corresponding boolean-valued expressions.

In a variation on this embodiment, automatically generating the observations can involve partitioning the test results based on one or more outcome conditions specified in the set of test results, and then generating observations for separately for each partition.

In a variation on this embodiment, the system automatically generates the observations by analyzing the code-under-test to produce a set of candidate boolean-valued expressions. Next, the system eliminates any candidate boolean-valued expressions which are not consistent with the set of test inputs and the set of test results, and promotes the remaining candidate expressions, which were not eliminated, to become observations.

In a variation on this embodiment, the boolean-valued expressions that comprise the observations can include: inputs to the code-under-test; results produced by the code-under test; variables within the code-under-test, which are visible/accessible outside of a method (or function) body; observations of the state of the system obtained through programmatic interface; and properties of objects.

In a variation on this embodiment, the boolean-valued expressions that comprise the observations can include: boolean operators or functions, relational operators or functions, arithmetic operators or functions, operators or functions on objects, operators or functions on types, and many other possible operators or functions.

In a variation on this embodiment, exercising the code-under-test involves first compiling the code-under-test to produce executable code, and then executing the executable code using the set of test inputs to produce the set of test results.

### BRIEF DESCRIPTION OF THE FIGURES

FIG. 1 presents a flow chart illustrating the code testing process in accordance with an embodiment of the present invention.

FIG. 2 is a diagram illustrating the relationship between expressions, observations and assertions in accordance with an embodiment of the present invention.

FIG. 3 illustrates the process of automatically generating observations and promoting the assertions to become observations in accordance with an embodiment of the present invention.

FIG. 4 illustrates the process of verifying assertions in accordance with an embodiment of the present invention.

FIG. 5 presents a flow chart illustrating the process of automatically generating observations from the code-under-test in accordance with an embodiment of the present invention.

FIG. 6 presents a flow chart illustrating the process of promoting observations to become assertions in accordance with an embodiment of the present invention.

FIG. 7 presents a flow chart illustrating the process of verifying assertions of a subsequent version of the code-under-test in accordance with an embodiment of the present invention.

FIG. 8 presents a flow chart illustrating in accordance with an embodiment of the present invention.

Table 1 illustrates a set of test inputs in accordance with an embodiment of the present invention.

Table 2 illustrates a set of test results in accordance with an embodiment of the present invention.

Table 3 illustrates a set of boolean-valued expressions in accordance with an embodiment of the present invention.

Table 4 illustrates results of checking a boolean-valued expression in accordance with an embodiment of the present invention.

Table 5 illustrates results of checking another boolean-valued expression in accordance with an embodiment of the present invention.

Table 6 illustrates a set of observations in accordance with an embodiment of the present invention.

Table 7 illustrates how an observation is selected to become an assertion in accordance with an embodiment of the present invention.

Table 8 illustrates test inputs to be used for assertion verification in accordance with an embodiment of the present invention.

Table 9 illustrates results of the assertion verification process for modified code in accordance with an embodiment of the present invention.

Table 10 illustrates other results for the assertion verification process for the modified code in accordance with an embodiment of the present invention.

Table 11 illustrates a set of observations for the modified code in accordance with an embodiment of the present invention.

Table 12 illustrates a set of observations for an outcome partition in accordance with an embodiment of the present invention.

Table 13 illustrates a set of observations for another outcome partition in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Code Testing Process

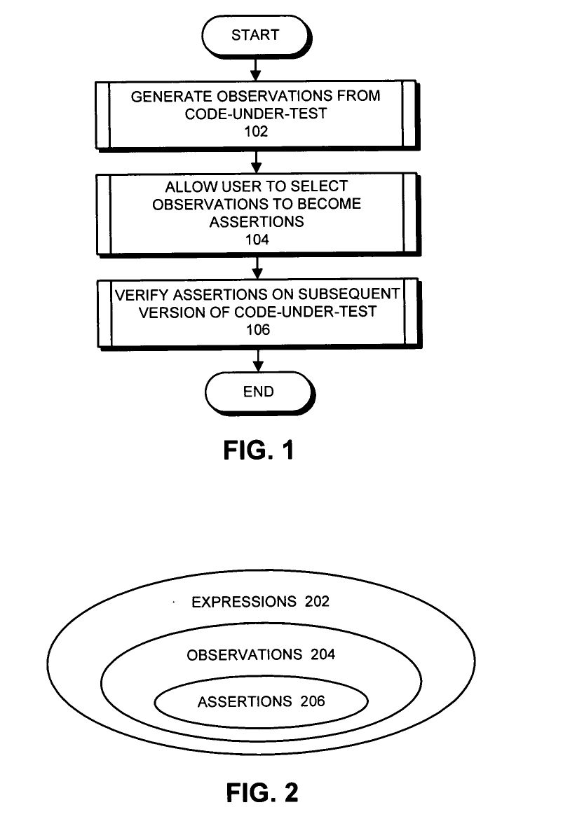

FIG. 1 presents a flow chart illustrating the code-testing process in accordance with an embodiment of the present invention. At a high-level of abstraction, this code-testing process involves three phases: (1) observation generation; (2) assertion generation; and (3) assertion verification.

During the first phase, the system generates observations by exercising the code-under-test repeatedly with a range of different inputs, to generate a set of observations about the behavior of the code (step 102 in FIG. 1).

Next, the system allows the users to select observations to become assertions which reflect the desired and/or expected behavior of the code (step 104). This involves displaying observations (i.e. candidates for assertions) to the user, and allowing the user to select observations to be promoted to become assertions.

Note that the user can place each observation into one of three major categories and can take a corresponding set of actions.

(1) If the observation matches the desired/expected behavior of the code, the user can select the observation (e.g. by clicking on a checkbox on the GUI) to be promoted to become an assertion.

(2) If the observation does not match the desired/expected behavior of the code, the mismatch between the observation's actual and desired/expected behavior typically indicates an error in the code, or a misunderstanding of the desired/expected behavior. In this case, the user can review the code, the specification, or both and make the appropriate changes and can then retest the code until the desired behavior is observed.

(3) If the observation is true, but it is uninteresting or irrelevant, the user can simply ignore the observation.

Finally, after some of the observations become assertions, the system verifies the assertions on subsequent versions of the code-under-test (step 106). The purpose of this phase is to re-exercise the code under test to verify that the assertions that were selected in the previous phase are still true.

In normal usage, the observation generation phase (steps 102 and 104) is run once—to generate the tests, and that the assertion verification phase (step 106) is run several times. The generated tests are used as part of a regression test suite and are run on a regular basis to make sure that no bugs are introduced as the software evolves. This model is similar to what people do with manually developed regression tests: once a test is created, it becomes part of a regression test suite that is run on a regular basis.

Relationships Between Expressions, Observations and Assertions

FIG. 2 is a diagram illustrating the relationship between expressions 202, observations 204 and assertions 206 in accordance with an embodiment of the present invention. Expressions 202 are boolean-valued expressions (for example written in the Java programming language), which hold true for the code-under-test. Expressions 202 are typically obtained by analyzing the code-under-test to determine relationships between: inputs to the code-under-test; results produced by the code-under test; variables within the code-under-test, which are visible/accessible outside of a method (or function) body; observations of the state of the system obtained through programmatic interface; and properties of objects.

These relationships can be expressed using: boolean operators or functions, relational operators or functions, arithmetic operators or functions, operators or functions on objects, operators or functions on types, and many other possible operators or functions.

Expressions that hold true while exercising the code-under-test become observations 204. Note that many expressions 202 will not hold true when the code-under-test it executed; these expressions will not become observations.

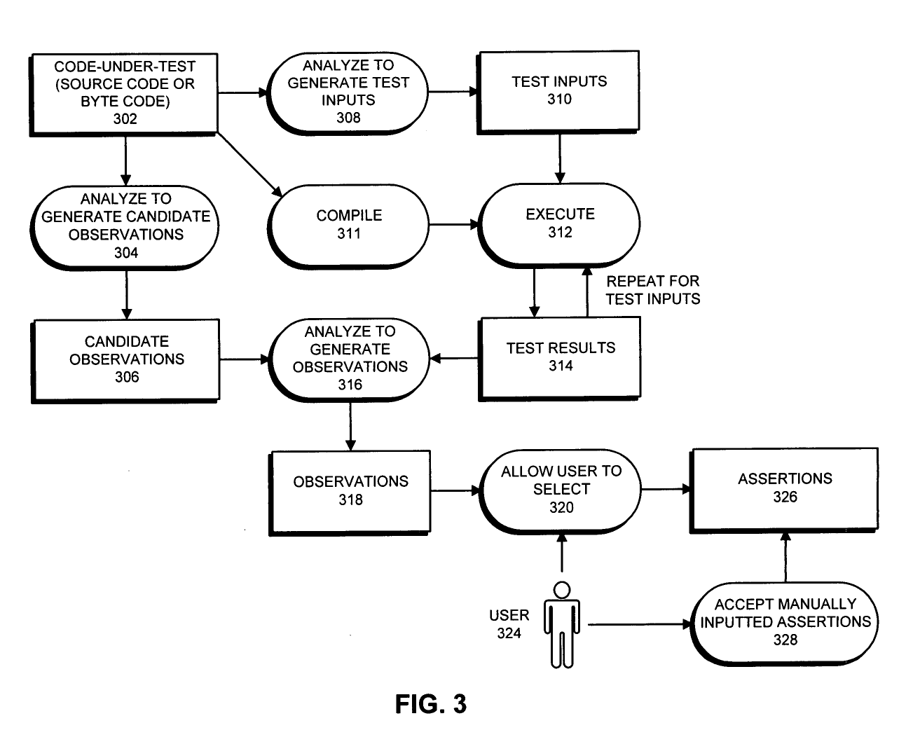

Finally, any observations which are selected by the user are promoted to become assertions 206, which will be verified against subsequent versions of the code under test. The process of generating expressions, observations and assertions is described in more detail below with reference to FIGS. 3-7.

Whenever possible, expressions are made as general as possible by using variables instead of constants. The generalized/parameterized form of the resulting observations (and assertions) makes them suitable for use with a broad set of input data. Non-generalized assertions are only useful and applicable when the specific input condition is met.

For example, the assertion: wordLength (“example”)==7, is only useful for testing the case where the word being analyzed is “example”. On the other hand, generalized observations can be useful and applicable over a wide range of inputs. The assertion: wordLength (anyword)>=0, for example, can be applied to any number of words. This is useful because the assertions can be used in conjunction with a new set of either random or pre-defined input data to increase the level of confidence in the tested function.

Process of Generating Observations and then Assertions

FIG. 3 illustrates the process of automatically generating observations and promoting the assertions to become observations in accordance with an embodiment of the present invention. The system starts with the code-under-test 302, which can be any type of high-level source code or byte code. Next, the system analyzes 304 the code-under-test 302 to generate possible boolean-valued expressions for the code, which become candidate observations 306.

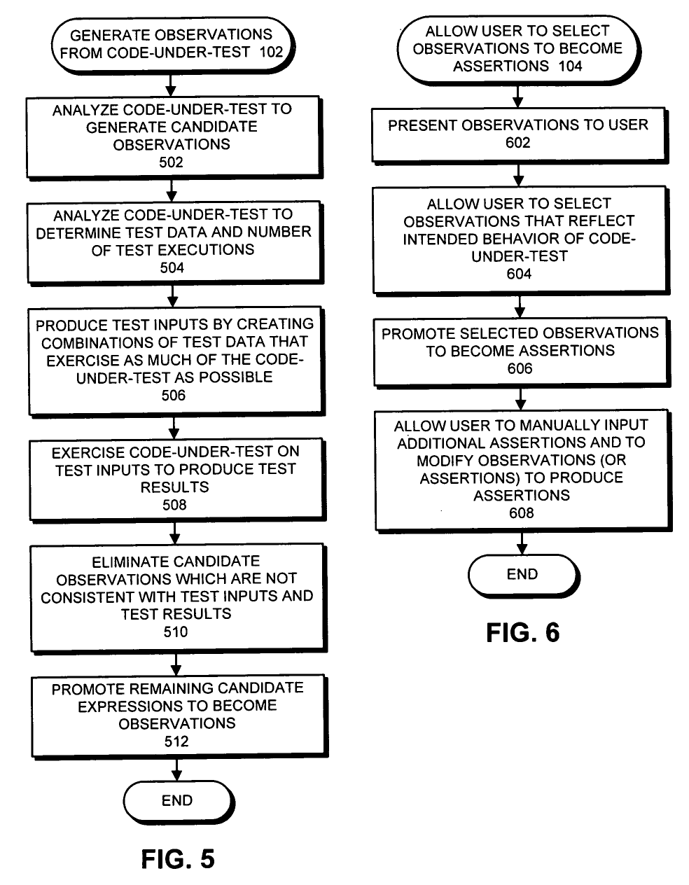

The system also analyzes the code-under-test 308 to generate a set of test inputs 310. (This process is described in more detail below with reference to FIG. 5.)

Next, the system compiles 311 code-under-test 302 into an executable version, and then repeatedly executes 312 this executable version using various test inputs 310 to produce a set of test results 314. The system then analyzes 316 the test results 314. In doing so, the system eliminates candidate observations 306 which are not consistent with the test results 314. The remaining candidate observations are promoted to become observations 318.

Next, the system then allows a user 324 to select 320 some of the observations 318 which reflect the intended behavior of the code-under-test to become assertions 326. The system can also accept manually inputted assertions from user 324, and can accept observations (or assertions) that have been modified by user 324 to produce assertions. At this point, the assertions 326 have been generated and are ready to be used to test subsequent versions of the code-under-test. This process is described in more detail below.

Process of Verifying Assertions

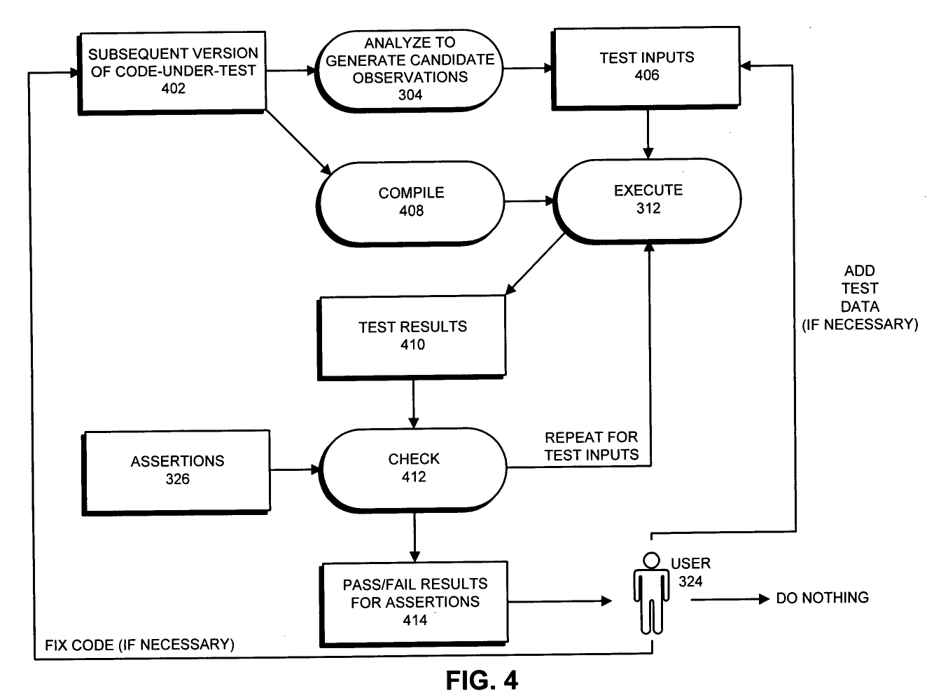

FIG. 4 illustrates the process of verifying assertions in accordance with an embodiment of the present invention. This process starts with a subsequent version of the code under test 402, which has been modified from the original code-under-test 302. The system analyzes 304 this subsequent version of code-under-test 308 to generate a set of test inputs 406. (Note that since the code-under-test 302 may have been modified, it is desirable to generate a new set of test inputs 406, which are structured to exercise the modified version of the code-under-test, instead of reusing the previously generated set of test inputs 310.)

Next, the system compiles 311 the subsequent version of code-under-test 402 into an executable version, and then repeatedly executes 312 this executable version using various test inputs 406 to produce a set of test results 410. During this repetitive testing process, the system checks 412 the assertions 326 against the test results 410.

Finally, the system reports pass/fail results for the assertions to user 324. This allows user 324 to take a number of actions: (1) user 324 can fix bugs in the subsequent version of code-under-test 402 and can then rerun the test; (2) user 324 to can add test data, if necessary; and (3) user 324 can do nothing if the test results 410 do not indicate any problems.

Some portions of the above-described processes which are illustrated in FIGS. 3 and 4 are described in more detail below with reference to FIGS. 5-7.

Process of Automatically Generating Observations

FIG. 5 presents a flow chart illustrating the process of automatically generating observations from the code-under-test in accordance with an embodiment of the present invention. The system starts by analyzing the code-under-test to generate a set of boolean-valued expressions about the code-under-test (step 502). As mentioned above, these boolean-valued expressions can specify relationships between: inputs to the code-under-test; results produced by the code-under test; variables within the code-under-test, which are visible/accessible outside of a method (or function) body; observations of the state of the system obtained through programmatic interface; and properties of objects.

Moreover, these relationships can be expressed using: boolean operators or functions, relational operators or functions, arithmetic operators or functions, operators or functions on objects, operators or functions on types, and many other possible operators or functions.

Next, the system analyzes the code-under-test to determine a relevant set of test data for the code and a number of test executions (step 504). Any of a number of different well-known techniques can be used to generate this test data, so this process will not be described further in this specification.

The number of test executions, can be a function of the complexity of code and/or the number and complexity of its inputs and/or the maximum amount of execution time set by the user and/or other possible variables (e.g. availability of test data). An infinite number of possible algorithms for determining this number that can be used. For example, the number of test executions can be calculated as: number of lines of code*number of parameters*EXECUTION_MULTIPLIER.

Next, the system produces a set of test inputs by creating combinations of the test data that exercise as much of the code-under-test as possible (step 506). The system then exercises a compiled version of the code-under-test on the test inputs to generate a set of test results (step 508).

The system uses these test results to eliminate candidate observations, which are not consistent with the test inputs and the test results (step 510). The remaining candidate expressions become observations (step 512).

Process of Promoting Observations to Become Assertions

FIG. 6 presents a flow chart illustrating the process of promoting observations to become assertions in accordance with an embodiment of the present invention. The system starts by presenting observations, which were automatically generated for the code-under-test, to a user (step 602). Next, the system allows the user to select observations that reflect the intended and/or expected behavior of the code-under-test (step 604); the system promotes these selected observations to become assertions (step 606).

The system also allows the user to manually input additional assertions and to modify observations (or assertions) to produce assertions (step 608). This allows the user to specify assertions, which cannot be easily generated by the above-described automatic process.

Process of Verifying Assertions

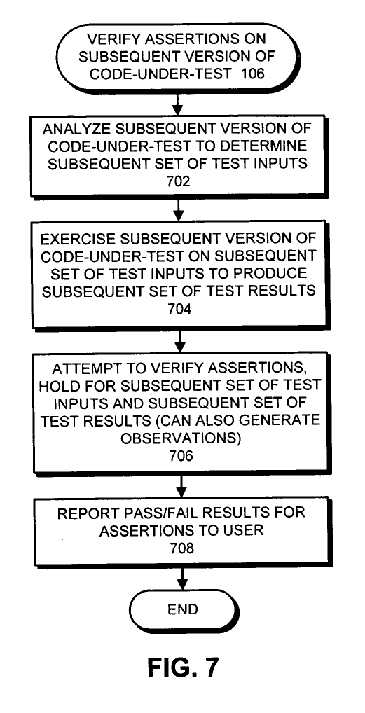

FIG. 7 presents a flow chart illustrating the process of verifying assertions of a subsequent version of the code-under-test in accordance with an embodiment of the present invention. The system starts by analyzing the subsequent version of the code-under-test to determine a subsequent set of test inputs (step 702). Next, the system exercises the subsequent version of the code-under-test on the subsequent set of test inputs to produce a subsequent set of test results (step 704).

The system then attempts to verify that the assertions hold for the subsequent set of test inputs and the subsequent set of test results (step 706). (Note that the system can also generate additional observations while the system is verifying assertions.) Finally, the system reports pass-fail results for the assertions to a user (step 708).

An example of this assertion generation and verification process is presented below.

### EXAMPLE

For the present example, we start with the following code-under-test.

int add(int x, int y) {
return x + y;
}

Observation Generation

During the observation generation phase, this code-under-test is analyzed to determine the required test data and number of test executions. In this simple example, the required test data is a pair of integers.

Assume that the number of test executions is calculated as: the number of lines of code*the number of parameters*100. With this assumption, the number of test executions for the present example is 1*2*100=200.

TABLE 1

| Test Case # | X | Y |
|---|---|---|
| 1 | 0 | 0 |
| 2 | 0 | −1 |
| 3 | 1 | 8192 |
| 4 | 8192 | 3423 |
| 5 | −1 | −43423 |
| . | . | . |
| . | . | . |
| . | . | . |
| 198 | 3244 | 754 |
| 199 | −78654 | 2 |
| 200 | 8192 | 0 |

Next, the system creates various combinations of the test data to produce test inputs that exercise as much of the code-under-test as possible. In the present example, there are no integer constants in the code (e.g. no statements of the form x>3, which would cause the system to include the number 3 as well as 2 and 4 (to check for off-by-one errors)). Hence, the system will create a set of inputs from a pre-determined set of interesting integers (e.g. 0, 1, −1, 8192, 8192, −8191, −8192, . . . ) and a random integer generator.

For example, the set of generated test inputs can look something like the test inputs that appear in Table 1 above.

Next, the system calls the code-under-test with each of the test inputs and stores the results. In the present example, the output of this operation appears in Table 2.

TABLE 2

| Test Case # | X | Y | RETURN |
|---|---|---|---|
| 1 | 0 | 0 | 0 |
| 2 | 0 | −1 | −1 |
| 3 | 1 | 8192 | 8193 |
| 4 | 8192 | 3423 | 11615 |
| 5 | −1 | −43423 | −43424 |
| . | . | . | . |
| . | . | . | . |
| . | . | . | . |
| 198 | 3244 | 754 | 3998 |
| 199 | −78654 | 2 | −78652 |
| 200 | 8192 | 0 | 8192 |

TABLE 3

X == Y
X >= Y
...
RETURN == X
RETURN > X
...
RETURN == X + Y
RETURN == X − Y
RETURN == −X − Y
...

Next, the system analyzes the set of results and generates a set of observations (if any). To generate observations, the system looks at the types in the results table, determines which predicates, operators, and relations are applicable, and creates a list of boolean-valued expressions to evaluate. In the present example, we have three integers, so the list of boolean-valued expressions to evaluate will look something like the expressions that appear in Table 3 above.

The list of possible boolean-valued expressions is applied to each set of values in the test results table. Table 4 shows the results of checking the boolean expression X>=Y.

TABLE 4

| Test Case # | X | Y | RETURN | X >= Y |
|---|---|---|---|---|
| 1 | 0 | 0 | 0 | TRUE |
| 2 | 0 | −1 | −1 | TRUE |
| 3 | 1 | 8192 | 8193 | FALSE |
| 4 | 8192 | 3423 | 11615 | TRUE |
| 5 | −1 | −43423 | −43424 | TRUE |
| . | . | . | . | . |
| . | . | . | . | . |
| . | . | . | . | . |
| 198 | 3244 | 754 | 3998 | TRUE |
| 199 | −78654 | 2 | −78652 | FALSE |
| 200 | 8192 | 0 | 8192 | TRUE |

TABLE 5

| Test Case # | X | Y | RETURN | RETURN == X + Y |
|---|---|---|---|---|
| 1 | 0 | 0 | 0 | TRUE |
| 2 | 0 | −1 | −1 | TRUE |
| 3 | 1 | 8192 | 8193 | TRUE |
| 4 | 8192 | 3423 | 11615 | TRUE |
| 5 | −1 | −43423 | −43424 | TRUE |
| . | . | . | . | . |
| . | . | . | . | . |
| . | . | . | . | . |
| 198 | 3244 | 754 | 3998 | TRUE |
| 199 | −78654 | 2 | −78652 | TRUE |
| 200 | 8192 | 0 | 8192 | TRUE |

Since for cases 3 and 199 the expression X>=Y is false, the expression X>=Y is not true in all cases. Consequently, the system determines that X>=Y should not be reported as an observation. On the other hand, the Boolean expression RETURN==X+Y is true for all cases and is therefore reported as an observation (see Table 5).

At the end of this process, the system will report a set of observations that might look something what appears in Table 6.

TABLE 6

| Observation # | Observation |
|---|---|
| 1 | RETURN == X + Y |
| 2 | RETURN >= −8734324 |
| 3 | RETURN <= 3243242 |

Observation Evaluation and Promotion

Next, during the observation evaluation and promotion process, the system displays the generated observations to a user. If the user determines that an observation reflects the intended behavior of the code, the user marks the observation as an assertion. For example, in Table 7, the user determines that observation #1 is an accurate and adequate specification of the intent of the code under test, so the user marks it to be promoted to become an assertion.

The other observations are true. However, since the specific range of the return value is an uninteresting artifact of the test inputs, the user did not select them.

TABLE 7

| Observation # | Observation | Promote to Assertion |
|---|---|---|
| 1 | RETURN == X + Y | YES |
| 2 | RETURN >= −8734324 | NO |
| 3 | RETURN <= 3243242 | NO |

At this point, the selected assertion (RETURN==X+Y) is stored in a file for use in the assertion verification phase.

Assertion Verification

During, the assertion verification phase, the system analyzes the code-under-test to determine the required test data. Note that the code-under-test, or other code it depends on, may have changed which may cause a different set of test data to be generated. Next, the system creates a variety of test inputs (i.e. combinations of test data) with the intent to exercise as much of the code under test as possible. Each testing operation is likely to generate new random values to accompany the default pre-determined values (e.g. 0, 1, −1, etc.), so the table of test inputs will be different in this assertion verification step (see Table 8).

TABLE 8

| Test Case # | X | Y |
|---|---|---|
| 1 | 0 | 0 |
| 2 | 0 | −1 |
| 3 | 1 | 8192 |
| 4 | 8192 | 777 |
| 5 | −1 | −124 |
| . | . | . |
| . | . | . |
| . | . | . |
| 198 | 3235 | 23 |
| 199 | −72334 | 2 |
| 200 | 8192 | 0 |

Next, the system executes the code-under-test with each of the test inputs. After each execution, for each assertion a in the set of assertions A, if a is true, the systems increments the pass counter for the assertion. Otherwise, the system increments the fail counter for the assertion.

The system then reports the pass/fail results for each assertion and the overall pass/fail results. (During typical usage, any assertion failure results in an overall test failure.)

Assuming the code-under-test has not changed (or at least its behavior has not changed) the selected assertion will be true in all 200 test execution cases and the code will pass the test (see Table 9).

TABLE 9

| Observation | | | | |
|---|---|---|---|---|
| # | Observation | TRUE | FALSE | TEST RESULT |
| 1 | RETURN == X + Y | 200 | 0 | PASS |

Changing the Code-Under-Test and Finding a Potential Bug

Now, suppose that the code-under-test is (arbitrarily) changed to the following.

```
int add(int x, int y) {
    if (x != 3333)
        return x + y ;
    else
        return −1111 ;
}
```

When this code is retested, the results will report something like what appears in Table 10.

To achieve this result, the analysis step determines that, in addition to default and random integer values, it should use the number 3333 as part of its test data because a simple data-flow analysis reveals that the number 3333 has an impact on which branch of the conditional statement is executed.

TABLE 10

| Observation | | | | |
|---|---|---|---|---|
| # | Observation | TRUE | FALSE | TEST RESULT |
| 1 | RETURN == X + Y | 195 | 5 | FAIL |

The assertion that used to be consistently true in all 200 code executions, does not hold when X==3333. In this case, the system automatically generates test data to cause that particular branch of the code to execute, and then reports that the desired and selected assertion did not hold. Note that it is unlikely that the previous set of test data included 3333, since that number did not have any special significance for the previous version of the code.

TABLE 11

| Observation # | Observation |
|---|---|
| 1 | IF X != 3333 → RETURN == X + Y |
| 2 | IF X != 3333 → RETURN >= −873423 |
| 3 | IF X != 3333 → RETURN <= 6363636 |
| 4 | IF X == 3333 → RETURN == −1111 |
| . | . |
| . | . |
| . | . |

When an assertion fails, the failure can be caused by an unintentional bug in the code under test or other code on which it depends, or by an intentional change to the code under test. In the former case, the developer debugs the code to fix the bug(s). In the latter case, the developer can change the assertions by manually editing them, or by re-running the system on the new code and selecting the appropriate assertions. If system is run on the new code, it will generate a new set of observations that might look something the observations that appear in Table 11.

If the code is indeed designed to behave differently when the value of X is equal to 3333, then the developer should promote observations #1 and #4 in Table 10 to become assertions.

Outcome Partitioning

In many cases, an observation only holds true for a specific outcome, wherein an outcome is a combination of inputs and/or outputs that share a common property. In these cases, it is useful to partition the test results based on one or more outcome conditions, and to generate observations separately for each partition. For example, in Table 11, the value of X creates two distinct outcomes. In one case (where X !=3333), the observations appear in Table 12 below.

TABLE 12
Partition X != 3333

| Observation # | Observation |
|---|---|
| 1 | RETURN == X + Y |
| 2 | RETURN >= −873423 |
| 3 | RETURN <= 6363636 |

and in the case where X==3333, we get the single observation that appears below in Table 13.

TABLE 13
Partition X == 3333

| Observation # | Observation |
|---|---|
| 1 | RETURN == −1111 |

Although the examples presented above illustrate how the present invention can be used in the context of a non-object-oriented system, the present invention can also be applied to objects defined within an object-oriented system.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

1. A method for automatically generating observations of program behavior for code testing purposes, comprising:
analyzing code-under-test to determine a set of test inputs;
exercising the code-under-test on the set of test inputs to produce a set of test results; and
analyzing the set of test results to automatically generate observations, wherein the observations are boolean-valued expressions containing variables and/or constants which are consistent with the set of test inputs and the set of test results.

2. The method of claim 1, wherein analyzing the code-under-test to determine the set of test inputs involves:
analyzing the code-under-test to determine test data for the code-under-test, and to determine a number of test executions; and
producing the set of test inputs by creating various combinations of the test data to exercise code-under-test.

3. The method of claim 1, wherein the method further comprises promoting observations to become assertions by:
presenting the observations, which were automatically generated, to a user;
allowing the user to select observations that reflect intended behavior of the code-under-test; and
promoting the selected observations to become assertions, which will be verified when a subsequent version of the code-under-test is exercised during subsequent testing.

4. The method of claim 3, wherein the method additionally involves allowing the user to:
manually enter assertions; and to
modify observations (or assertions) to produce assertions.

5. The method of claim 3, wherein presenting the observations to the user involves filtering and/or ranking the observations based on a relevance score before presenting the observations to the user.

6. The method of claim 3, wherein the method further comprises verifying assertions by:
exercising the subsequent version of the code-under-test on a subsequent set of test inputs to produce a subsequent set of test results;
verifying that the assertions hold for the subsequent set of test inputs and the subsequent set of test results; and
reporting pass/fail results for the assertions to the user, thereby allowing the user to fix any problems indicated by the pass/fail results.

7. The method of claim 6, wherein prior to exercising the subsequent version of the code-under-test, the method further comprises analyzing the subsequent version of the code-under-test to determine the subsequent set of test inputs to be used while exercising the subsequent version of the code-under-test.

8. The method of claim 1, wherein automatically generating the observations involves generalizing the observations, whenever possible, by using variables instead of constants in the corresponding boolean-valued expressions.

9. The method of claim 1, wherein automatically generating the observations can involve:
partitioning the test results based on one or more outcome conditions specified in the set of test results; and
generating observations for separately for each partition.

10. The method of claim 1, wherein automatically generating the observations involves:
analyzing the code-under-test to produce a set of candidate boolean-valued expressions;
eliminating any candidate boolean-valued expressions which are not consistent with the set of test inputs and the set of test results; and
promoting remaining candidate expressions, which were not eliminated, to become observations.

11. The method of claim 1, wherein the boolean-valued expressions that comprise the observations can include:
inputs to the code-under-test;
results produced by the code-under test;
variables within the code-under-test, which are visible/accessible outside of a method (or function) body;
observations of the state of the system obtained through programmatic interface; and
properties of objects.

12. The method of claim 1, wherein the boolean-valued expressions that comprise the observations can include:
boolean operators or functions;
relational operators or functions;
arithmetic operators or functions;
operators or functions on objects; and
operators or functions on types.

13. The method of claim 1, wherein exercising the code-under-test involves:
compiling the code-under-test to produce executable code; and
executing the executable code using the set of test inputs to produce the set of test results.

14. A computer-readable storage medium storing instructions that when executed by a computer cause the computer to perform a method for automatically generating observations of program behavior for code testing purposes, the method comprising:
analyzing code-under-test to determine a set of test inputs;
exercising the code-under-test on the set of test inputs to produce a set of test results; and
analyzing the set of test results to automatically generate observations, wherein the observations are boolean-valued expressions containing variables and/or constants which are consistent with the set of test inputs and the set of test results.

15. The computer-readable storage medium of claim 14, wherein analyzing the code-under-test to determine the set of test inputs involves:
analyzing the code-under-test to determine test data for the code-under-test, and to determine a number of test executions; and
producing the set of test inputs by creating various combinations of the test data to exercise code-under-test.

16. The computer-readable storage medium of claim 14, wherein the method further comprises promoting observations to become assertions by:
presenting the observations, which were automatically generated, to a user;
allowing the user to select observations that reflect intended behavior of the code-under-test; and
promoting the selected observations to become assertions, which will be verified when a subsequent version of the code-under-test is exercised during subsequent testing.

17. The computer-readable storage medium of claim 16, wherein the method additionally involves allowing the user to:
manually enter assertions; and to modify observations (or assertions) to produce assertions.

18. The computer-readable storage medium of claim 16, wherein presenting the observations to the user involves filtering and/or ranking the observations based on a relevance score before presenting the observations to the user.

19. The computer-readable storage medium of claim 16, wherein the method further comprises verifying assertions by:
exercising the subsequent version of the code-under-test on a subsequent set of test inputs to produce a subsequent set of test results;
verifying that the assertions hold for the subsequent set of test inputs and the subsequent set of test results; and
reporting pass/fail results for the assertions to the user, thereby allowing the user to fix any problems indicated by the pass/fail results.

20. The computer-readable storage medium of claim 19, wherein prior to exercising the subsequent version of the code-under-test, the method further comprises analyzing the subsequent version of the code-under-test to determine the subsequent set of test inputs to be used while exercising the subsequent version of the code-under-test.

21. The computer-readable storage medium of claim 14, wherein automatically generating the observations involves generalizing the observations, whenever possible, by using variables instead of constants in the corresponding boolean-valued expressions.

22. The computer-readable storage medium of claim 14, wherein automatically generating the observations can involve:
partitioning the test results based on one or more outcome conditions specified in the set of test results; and
generating observations for separately for each partition.

23. The computer-readable storage medium of claim 14, wherein automatically generating the observations involves:
analyzing the code-under-test to produce a set of candidate boolean-valued expressions;
eliminating any candidate boolean-valued expressions which are not consistent with the set of test inputs and the set of test results; and
promoting remaining candidate expressions, which were not eliminated, to become observations.

24. The computer-readable storage medium of claim 14, wherein the boolean-valued expressions that comprise the observations can include:
inputs to the code-under-test;
results produced by the code-under test;
variables within the code-under-test, which are visible/accessible outside of a method (or function) body;
observations of the state of the system obtained through programmatic interface; and
properties of objects.

25. The computer-readable storage medium of claim 14, wherein the boolean-valued expressions that comprise the observations can include:
boolean operators or functions;
relational operators or functions;
arithmetic operators or functions;
operators or functions on objects; and
operators or functions on types.

26. The computer-readable storage medium of claim 14, wherein exercising the code-under-test involves:
compiling the code-under-test to produce executable code; and
executing the executable code using the set of test inputs to produce the set of test results.

27. An apparatus that automatically generates observations of program behavior for code testing purposes, comprising:
a test input generation mechanism configured to analyze code-under-test to determine a set of test inputs;
an execution mechanism configured to exercise the code-under-test on the set of test inputs to produce a set of test results; and
an observation generation mechanism configured to analyze the set of test results to automatically generate observations, wherein the observations are boolean-valued expressions containing variables and/or constants which are consistent with the set of test inputs and the set of test results.

28. The apparatus of claim 27, wherein the test input generation mechanism is configured to:
analyze the code-under-test to determine test data for the code-under-test, and to determine a number of test executions; and to
produce the set of test inputs by creating various combinations of the test data to exercise code-under-test.

29. The apparatus of claim 27, wherein the apparatus further comprises an assertion generation mechanism, which is configured to:
present the observations, which were automatically generated, to a user;
allow the user to select observations that reflect intended behavior of the code-under-test; and to
promote the selected observations to become assertions, which will be verified when a subsequent version of the code-under-test is exercised during subsequent testing.

30. The apparatus of claim 29, wherein the assertion generation mechanism is additionally configured to allow the user to:
manually enter assertions; and to
modify observations (or assertions) to produce assertions.

31. The apparatus of claim 29, wherein while presenting the observations to the user, the assertion generation mechanism is configured to filter and/or rank the observations based on a relevance score before presenting the observations to the user.

32. The apparatus of claim 29, wherein the apparatus further comprises an assertion verification mechanism, which is configured to:
exercise the subsequent version of the code-under-test on a subsequent set of test inputs to produce a subsequent set of test results;
verify that the assertions hold for the subsequent set of test inputs and the subsequent set of test results; and to
report pass/fail results for the assertions to the user, thereby allowing the user to fix any problems indicated by the pass/fail results.

33. The apparatus of claim 32, wherein prior to exercising the subsequent version of the code-under-test, the test input generation mechanism is configured to analyze the subsequent version of the code-under-test to determine the subsequent set of test inputs to be used while exercising the subsequent version of the code-under-test.

34. The apparatus of claim 27, wherein while automatically generating the observations, the observation generation mechanism is configured to generalize the observations, whenever possible, by using variables instead of constants in the corresponding boolean-valued expressions.

35. The apparatus of claim 27, wherein while automatically generating the observations, the observation generation mechanism is configured to:
partition the test results based on one or more outcome conditions specified in the set of test results; and to
generate observations for separately for each partition.

36. The apparatus of claim 27, wherein while automatically generating the observations, the observation generation mechanism is configured to:
analyze the code-under-test to produce a set of candidate boolean-valued expressions;
eliminate any candidate boolean-valued expressions which are not consistent with the set of test inputs and the set of test results; and to
promote remaining candidate expressions, which were not eliminated, to become observations.

37. The apparatus of claim 27, wherein the boolean-valued expressions that comprise the observations can include:
inputs to the code-under-test;
results produced by the code-under test;
variables within the code-under-test, which are visible/accessible outside of a method (or function) body;
observations of the state of the system obtained through programmatic interface; and
properties of objects.

38. The apparatus of claim 27, wherein the boolean-valued expressions that comprise the observations can include:
boolean operators or functions;
relational operators or functions;
arithmetic operators or functions;
operators or functions on objects; and
operators or functions on types.

39. The apparatus of claim 27, wherein while exercising the code-under-test the execution mechanism is configured to:
compile the code-under-test to produce executable code; and to
execute the executable code using the set of test inputs to produce the set of test results.

40. A means for automatically generating observations of program behavior for code testing purposes, comprising:
a test input generation means for analyzing code-under-test to determine a set of test inputs;
an execution means for exercising the code-under-test on the set of test inputs to produce a set of test results; and
an observation generation means for analyzing the set of test results to automatically generate observations, wherein the observations are boolean-valued expressions containing variables and/or constants which are consistent with the set of test inputs and the set of test results.
